(19) United States
(12) Patent Application Publication
(10) Pub. No.: US 2025/0217273 A1
(43) Pub. Date: Jul. 3, 2025

(54) ATTRIBUTION TEST METHOD AND APPARATUS, ELECTRONIC DEVICE, STORAGE MEDIUM, AND SYSTEM

(71) Applicants: Beijing Zitiao Network Technology Co., Ltd., Beijing (CN); Beijing Youzhuju Network Technology Co., Ltd., Beijing (CN); Lemon Inc., Grand Cayman (KY)

(72) Inventors: Yuting Bian, Beijing (CN); Runshan Wang, Beijing (CN); Ye Li, Beijing (CN); Xuewu Huang, Beijing (CN); Yu Jie Tai, Singapore (SG); Shihao Liu, Beijing (CN); Yuxin Zhang, Beijing (CN)

(21) Appl. No.: 19/001,875

(22) Filed: Dec. 26, 2024

(30) Foreign Application Priority Data
Dec. 27, 2023 (CN) 202311827918.9

(51) Int. Cl. G06F 11/3698; G06F 8/61

(52) U.S. Cl. CPC G06F 11/3698; G06F 8/61

(57) ABSTRACT

Embodiments of the present disclosure provide an attribution test method and apparatus, an electronic device, a storage medium, and a system. The method includes: sending a preset control instruction to a second terminal, wherein the preset control instruction is used to instruct the second terminal to perform attribution detection on an installation channel of an application to be tested and generate an attribution detection result, and the application to be tested is installed in the second terminal; receiving the attribution detection result that is returned by the second terminal in response to the preset control instruction; and generating, based on the attribution detection result and an expected detection result for the application to be tested, an attribution test result for the application to be tested.

### CROSS-REFERENCE TO RELATED APPLICATION(S)

This application claims priority to Chinese Application No. 202311827918.9 filed Dec. 27, 2023, the disclosure of which is incorporated herein by reference in its entirety.

### FIELD

Embodiments of the present disclosure relate to the field of computer technologies, and in particular, to an attribution test method and apparatus, an electronic device, a storage medium, and a system.

### BACKGROUND

Pre-installation means installing, in advance, applications on devices that are about to be shipped by manufacturers or operators, to facilitate use of the applications by users who purchase the devices. Pre-installation attribution is an important part of pre-installation. When the pre-installation attribution is performed, it is necessary to accurately identify the channel from which an application is installed, to further determine the effect of pre-installation.

In a pre-installation cooperation procedure, attribution solution testing is an important link, which is often carried out in a purely manual manner in the past. The specific method is described as follows. A tester completes installation of a pre-installed application; the tester manually resets a unique identification code (Identity Document, ID) of a device on a settings page, activates the pre-installed application, and completes attribution, and the application records attribution information; the tester finds an entry for detailed information of the application, for example, by quickly clicking on an application version number multiple times to obtain the attribution information about the application; and the tester provides a screenshot of the attribution information to a business party of the application, for verification of whether the attribution information meets expectations.

However, the attribution solution testing in the prior art involves complicated operations and is error-prone, and is relatively expensive in communication during testing.

### SUMMARY

Embodiments of the present disclosure provide an attribution test method and apparatus, an electronic device, a storage medium, and a system, to improve the efficiency of an attribution solution test and the accuracy of an attribution solution test result.

According to a first aspect, an embodiment of the present disclosure provides an attribution test method, which is applied to a first terminal. The method includes:
sending a preset control instruction to a second terminal, wherein the preset control instruction is used to instruct the second terminal to perform attribution detection on an installation channel of an application to be tested and generate an attribution detection result, and the application to be tested is installed in the second terminal;
receiving the attribution detection result that is returned by the second terminal in response to the preset control instruction; and
generating, based on the attribution detection result and an expected detection result for the application to be tested, an attribution test result for the application to be tested.

According to a second aspect, an embodiment of the present disclosure further provides an attribution test method, which is applied to a second terminal, the second terminal having an application to be tested installed therein. The method includes:
performing, in response to a preset control instruction sent by a first terminal, attribution detection on an installation channel of the application to be tested and generating an attribution detection result; and
sending the attribution detection result to the first terminal, wherein the attribution detection result is used by the first terminal to generate an attribution test result.

According to a third aspect, an embodiment of the present disclosure further provides an attribution test apparatus, which is configured in a first terminal. The apparatus includes: a control instruction sending module configured to send a preset control instruction to a second terminal, wherein the preset control instruction is used to instruct the second terminal to perform attribution detection on an installation channel of an application to be tested and generate an attribution detection result, and the application to be tested is installed in the second terminal; an attribution detection result receiving module configured to receive the attribution detection result that is returned by the second terminal in response to the preset control instruction; and a test result generation module configured to generate, based on the attribution detection result and an expected detection result for the application to be tested, an attribution test result for the application to be tested.

According to a fourth aspect, an embodiment of the present disclosure further provides an attribution test apparatus, which is configured in a second terminal, the second terminal having an application to be tested installed therein. The apparatus includes:
a detection result generation module configured to perform, in response to a preset control instruction sent by a first terminal, attribution detection on an installation channel of the application to be tested and generate an attribution detection result; and
an attribution detection result sending module configured to send the attribution detection result to the first terminal, wherein the attribution detection result is used by the first terminal to generate an attribution test result.

According to a fifth aspect, an embodiment of the present disclosure further provides an electronic device, including:
one or more processors; and
a memory configured to store one or more programs, where
the one or more programs, when executed by the one or more processors, cause the one or more processors to implement the attribution test method as described in the embodiments of the present disclosure.

According to a sixth aspect, an embodiment of the present disclosure further provides a computer-readable storage medium having a computer program stored thereon. The program, when executed by a processor, causes the attribution test method as described in the embodiments of the present disclosure to be implemented.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an attribution test method according to an embodiment of the present disclosure;

FIG. 2 is a schematic flowchart of another attribution test method according to an embodiment of the present disclosure;

FIG. 3 is a schematic flowchart of yet another attribution test method according to an embodiment of the present disclosure;

FIG. 4 is a schematic flowchart of a fourth attribution test method according to an embodiment of the present disclosure;

FIG. 5 is a diagram of an architecture of a pre-installation attribution test system according to an embodiment of the present disclosure;

FIG. 6 is a block diagram of a structure of an attribution test apparatus according to an embodiment of the present disclosure;

FIG. 7 is a block diagram of a structure of another attribution test apparatus according to an embodiment of the present disclosure;

FIG. 8 is a schematic diagram of a structure of an electronic device according to an embodiment of the present disclosure; and

FIG. 9 is a schematic diagram of a structure of an attribution test system according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/include” used herein and the variations thereof are an open-ended inclusion, namely, “include/include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

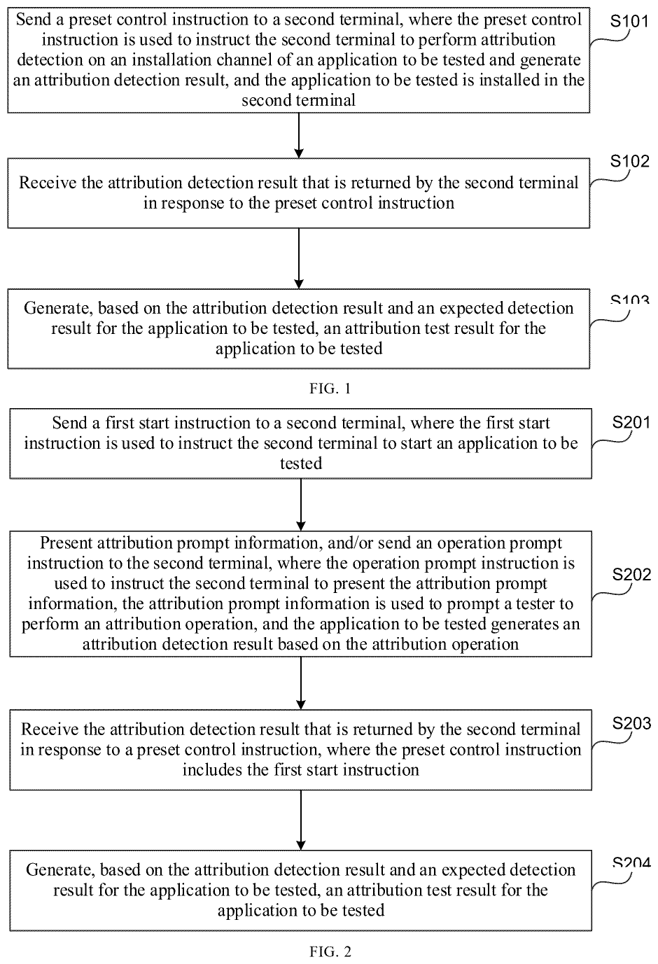

FIG. 1 is a schematic flowchart of an attribution test method according to an embodiment of the present disclosure. The method may be performed by an attribution test apparatus. The apparatus may be implemented by software and/or hardware, and may be configured in an electronic device, typically, in a computer, for example, in a first terminal. The attribution test method provided in this embodiment of the present disclosure is applicable to scenarios where an attribution solution test is performed, particularly to scenarios where an attribution solution test is performed on a pre-installed application. As shown in FIG. 1, the attribution test method provided in this embodiment may include the following steps.

S101: Send a preset control instruction to a second terminal, where the preset control instruction is used to instruct the second terminal to perform attribution detection on an installation channel of an application to be tested and generate an attribution detection result, and the application to be tested is installed in the second terminal.

The second terminal may be a terminal that has established a communication connection with the first terminal. Exemplarily, the first terminal may be a computer. Taking the application to be tested being an Android application as an example, an Android Debug Bridge (ADB) may be configured on the first terminal. The first terminal may perform the attribution test method provided in this embodiment through the configured ADB. The second terminal may be a mobile terminal, such as a mobile phone or a tablet computer, and the application to be tested may be installed on the second terminal.

The application to be tested may be understood as an application that is subjected to testing, such as an application for which an attribution solution for an installation channel needs to be tested. The installation channel may be understood as an installation source, which may be used to represent the way in which the application to be tested is installed on the second terminal. The preset control instruction may be used to instruct the second terminal to perform attribution detection for the installation channel of the installed application to be tested and generate the attribution detection result. The attribution detection result may be understood as a result generated by performing attribution detection, and the attribution detection result may include information about the installation channel of the application to be tested that is obtained through detection.

Specifically, the first terminal may send the preset control instruction to the second terminal to instruct, through the preset control instruction, the second terminal to perform, by using a configured attribution solution, attribution detection on the installation channel of the application to be tested and generate the attribution detection result, so as to facilitate subsequent attribution tests based on the attribution detection result generated by the second terminal. The attribution solution may be a solution in performing attribution detection for the installation channel of the application to be tested, and the specific content of the attribution solution is not limited.

S102: Receive the attribution detection result that is returned by the second terminal in response to the preset control instruction.

Exemplarily, after generating the attribution detection result in response to the preset control instruction sent by the first terminal, the second terminal may send the generated attribution detection result to the first terminal. Correspondingly, the first terminal may receive the attribution detection result sent by the second terminal.

In this embodiment, the manner in which the attribution detection result is sent to the first terminal is not limited. For example, the attribution detection result may be sent to the first terminal by the application to be tested installed in the second terminal, an attribution test application installed in the second terminal, a sending module of the second terminal itself, etc.

In some implementations, the attribution detection result is sent by the second terminal through the attribution test application, and before the sending a preset control instruction to a second terminal, the method further includes: sending an application detection instruction to the second terminal, and receiving an application detection result that is returned by the second terminal in response to the application detection instruction, wherein the application detection instruction is used to instruct the second terminal to perform installation status detection on the attribution test application; and sending a second start instruction to the second terminal in response to the application detection result indicating that the attribution test application is in an installed state, where the second start instruction is used to instruct the second terminal to start the attribution test application; or sending a second installation instruction to the second terminal in response to the application detection result indicating that the attribution test application is in an uninstalled state, and sending the second start instruction to the second terminal after the attribution test application has been installed, where the second installation instruction is used to instruct the second terminal to install the attribution test application.

The application detection instruction may be an instruction for instructing the second terminal to detect an installation status of the attribution test application. An installation status of an application (such as the attribution test application and/or the application to be tested) may be used to represent whether the application has been installed. Exemplarily, the installation status may include an installed state and an uninstalled state. The attribution test application may be an application used to assist in performing attribution testing, and the attribution test application may be installed on the second terminal.

The application detection result may be understood as a detection result obtained by performing detection on the installation status of the attribution test application, and the detection result may carry information about the installation status of the attribution test application. The second start instruction may be an instruction for instructing the second terminal to start the attribution test application installed therein. The second installation instruction may be an instruction for instructing the second terminal to install the attribution test application.

In the above implementation, the second terminal may assist in performing attribution testing through the attribution test application, such as collecting the generated attribution detection result through the attribution test application and sending the attribution detection result to the first terminal; the second terminal may provide a tester with a visual interface, such as to implement user interface (UI) interaction in a test procedure and/or presentation of the attribution test result; and/or the second terminal may report the generated attribution test result, etc.

In order to avoid a situation where the application to be tested is instructed to perform attribution detection when the attribution test application has not been installed, and thus reduce unnecessary operations on the second terminal side, whether the attribution test application is installed in the second terminal may be detected before the second terminal is instructed to perform attribution detection, and if the attribution test application is not installed, the second terminal may be instructed to complete installation of the attribution test application.

Exemplarily, the application detection instruction may be sent to the second terminal, to instruct, through the application detection instruction, the second terminal to perform installation status detection on the attribution test application; and the application detection result that is returned by the second terminal in response to the application detection instruction may be received.

If the application detection result indicates that the attribution test application is in an installed state in the second terminal, the second start instruction is sent to the second terminal, to instruct, through the second start instruction, the second terminal to start the attribution test application installed therein; and/or if the application detection result indicates that the attribution test application is in an uninstalled state in the second terminal, the second installation instruction is sent to the second terminal, to instruct, through the second installation instruction, the second terminal to install the attribution test application. After the attribution test application has been installed, for example, when installation complete information for the attribution test application sent by the second terminal is received, or when a new application detection result generated by controlling the second terminal to perform installation status detection on the attribution test application once again indicates that the attribution detection application is in an installed state, the second start instruction is sent to the second terminal, to instruct, through the second start instruction, the second terminal to start the attribution test application installed therein.

S103: Generate, based on the attribution detection result and an expected detection result for the application to be tested, an attribution test result for the application to be tested.

The expected detection result may be understood as a detection result that the second terminal is expected to generate, such as a standard detection result. The attribution test result may be a test result that is generated by testing the attribution solution used by the second terminal. Exemplarily, the attribution test result may be used to represent whether the attribution detection result for the application to be tested matches the expected detection result, and/or further indicate, when the attribution detection result for the application to be tested does not completely match the expected detection result, a result item in the attribution detection result for the application to be tested that matches the expected detection result and/or a result item in the attribution detection result for the application to be tested that does not match the expected detection result, etc.

In this embodiment, after the attribution detection result sent by the second terminal is received, the attribution test result for the application to be tested may be generated based on the attribution detection result and the expected detection result for the application to be tested. For example, the received attribution detection result is matched with the expected detection result for the application to be tested, and it is determined whether each result item in the attribution detection result is correct, to obtain a matching result therebetween as the attribution detection result for the application to be tested.

In some implementations, after the receiving the attribution detection result that is returned by the second terminal in response to the preset control instruction, the method further includes: sending an information obtaining instruction to the second terminal, and receiving display position information that is returned by the second terminal in response to the information obtaining instruction, where the display position information is used to indicate a display position of the application to be tested in the second terminal; and the generating, based on the attribution detection result and an expected detection result for the application to be tested, an attribution test result for the application to be tested comprises: generating, based on the attribution detection result, the expected detection result for the application to be tested, and the display position information, the attribution test result for the application to be tested.

The information obtaining instruction may be an instruction to obtain the display position information of the application to be tested from the second terminal. The display position information of the application to be tested may be information relating to the display position of the application to be tested in the second terminal. Exemplarily, the display position information may be position information of an application icon of the application to be tested when the application icon is displayed on a screen of the application to be tested, such as which page and/or row and column the icon of the application to be tested is located on a desktop of the second terminal.

In the above implementation, the attribution test result may further include the display position information of the application to be tested in the second terminal, so that relevant personnel (e.g., the tester and/or a business party of the application to be tested) may determine whether the display position of the application to be tested meets expectations. Compared with technical solutions in the prior art of it being impossible to collect display position information of an application to be tested or there being a need for a tester to obtain the display position information of the application to be tested by taking a screenshot manually, the above implementation can improve the comprehensiveness of attribution solution testing, reduce manpower consumed for the attribution solution testing, and meet diversified test result collection needs.

Exemplarily, after the attribution detection result that is returned by the second terminal in response to the preset control instruction is received, the information obtaining instruction may be sent to the second terminal, and the display position information of the application to be tested in the second terminal may be obtained from the second terminal through the information obtaining instruction, and the display position information that is returned by the second terminal in response to the information obtaining instruction may be received. Thus, the attribution test result for the application to be tested may be generated based on the attribution detection result and the expected detection result for the application to be tested, as well as the display position information of the application to be tested. For example, the attribution detection result for the application to be tested may be matched with the expected detection result to obtain a matching result, and an attribution detection result including the matching result and the display position information of the application to be tested may be generated.

In some implementations, the attribution detection result further carries an attribution test image at the second terminal, and before the sending a preset control instruction to a second terminal, the method further comprises: sending a screen recording instruction to the second terminal, wherein the screen recording instruction is used to instruct the second terminal to perform screen recording, to obtain the attribution test image at the second terminal; and before the generating, based on the attribution detection result and an expected detection result for the application to be tested, an attribution test result for the application to be tested, the method further comprises: receiving the attribution test image that is returned by the second terminal in response to the screen recording instruction.

In the above implementation, the attribution test result may further include the attribution test image for the application to be tested, so that relevant personnel may review and analyze the test process of the application to be tested based on the attribution test image for the application to be tested, so as to improve the attribution solution for the application to be tested.

Exemplarily, before the second terminal is instructed through the preset control instruction to perform attribution detection, the screen recording instruction may be sent to the second terminal, to instruct, through the screen recording instruction, the second terminal to perform screen recording, to obtain the attribution test image at the second terminal, and the attribution test image that is returned by the second terminal in response to the screen recording instruction may be received. For example, the second terminal may send, in real time, the attribution test image obtained though screen recording to the first terminal during the screen recording process, and/or send the attribution test image obtained through screen recording to the first terminal after the attribution detection is completed, for example, after the attribution detection result and/or the display position information of the application to be tested are sent to the first terminal. Correspondingly, the first terminal may receive the attribution test image sent by the second terminal. The screen recording instruction may be an instruction for instructing the second terminal to perform screen recording.

In some implementations, after the generating, based on the attribution detection result and an expected detection result for the application to be tested, an attribution test result for the application to be tested, the method further comprises at least one of the following: sending to the second terminal a result presentation instruction carrying the attribution test result, where the result presentation instruction is used to instruct the second terminal to present the attribution test result; and sending a reporting prompt instruction to the second terminal, where the reporting prompt instruction is used to instruct the second terminal to present reporting prompt information, and the reporting prompt information is used to trigger reporting of the attribution test result.

The result presentation instruction may be an instruction for instructing the second terminal to present the generated attribution test result. The reporting prompt instruction may be an instruction for instructing the second terminal to present the reporting prompt information. The reporting prompt information may be used to prompt the tester to report the generated attribution test result. For example, the tester may report the generated attribution test result with one click by triggering the reporting prompt information, etc.

In the above implementation, after the attribution test result is generated, the generated attribution test result may be sent to the second terminal for presentation and/or reporting by the second terminal, so that it can be viewed by the tester and/or the business party of the application to be tested.

Exemplarily, after the attribution test result is generated, the result presentation instruction carrying the attribution test result and/or the reporting prompt instruction carrying the attribution test result may be sent to the second terminal, to instruct, through the result presentation instruction, the second terminal to present the generated attribution test result, and/or to instruct, through the reporting prompt instruction, the second terminal to prompt, by presenting the reporting prompt information, the tester to report the generated attribution test result.

It may be appreciated that the result presentation instruction and/or the reporting prompt instruction may also not carry the generated attribution test result. For example, after the attribution test result is generated, the attribution test result may be sent to the second terminal, and then the result presentation instruction and/or the reporting prompt instruction may be sent to the second terminal, which may be specifically set as required.

In the attribution test method provided in this embodiment, the preset control instruction is sent to the second terminal, where the preset control instruction is used to instruct the second terminal to perform attribution detection on the installation channel of the application to be tested and generate the attribution detection result, and the application to be tested is installed in the second terminal; the attribution detection result that is returned by the second terminal in response to the preset control instruction is received; and the attribution test result for the application to be tested is generated based on the attribution detection result and the expected detection result for the application to be tested; With the above technical solution, this embodiment can improve the efficiency of an attribution solution test and the accuracy of an attribution solution test result by controlling, through the first terminal, the second terminal to test an attribution solution used for the application to be tested.

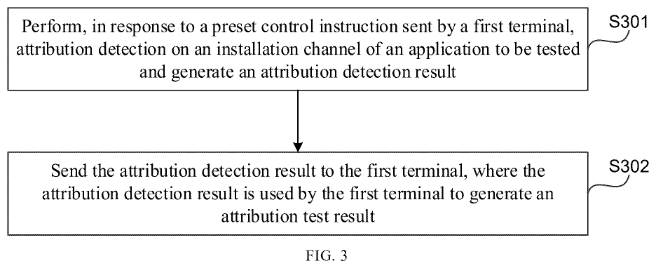

FIG. 2 is a schematic flowchart of another attribution test method according to an embodiment of the present disclosure. The solution in this embodiment may be combined with one or more optional solutions in the above embodiment. Optionally, the preset control instruction comprises a first start instruction, and the sending a preset control instruction to a second terminal comprises: sending the first start instruction to the second terminal, where the first start instruction is used to instruct the second terminal to start the application to be tested; and presenting attribution prompt information, and/or sending an operation prompt instruction to the second terminal, where the operation prompt instruction is used to instruct the second terminal to present the attribution prompt information, the attribution prompt information is used to prompt a tester to perform an attribution operation, and the application to be tested generates the attribution detection result based on the attribution operation.

Accordingly, as shown in FIG. 2, the attribution test method provided in this embodiment may include the following steps.

S201: Send the first start instruction to the second terminal, where the first start instruction is used to instruct the second terminal to start the application to be tested.

The first start instruction may be an instruction for instructing the second terminal to start the installed application to be tested.

In this embodiment, the first terminal may control the second terminal to start the application to be tested, so as to test an attribution solution used for the application to be tested. For example, the first terminal may send the first start instruction to the second terminal, to instruct, through the first start instruction, the second terminal to start the application to be tested installed in the second terminal.

In some implementations, it is possible to control the second terminal to perform environment detection, and then send the first start instruction to the second terminal if the environment detection is successful, thereby avoiding a situation where the first start instruction is sent to the second terminal when an attribution test cannot be performed in an environment of the second terminal. In this case, optionally, before the sending the first start instruction to the second terminal, the method further includes: sending an environment detection instruction to the second terminal, where the environment detection instruction is used to instruct an attribution test application to perform environment detection on the second terminal and generate an environment detection result, the attribution test application is installed in the second terminal, and the environment detection comprises network environment detection, and/or installation status detection for the application to be tested; and receiving the environment detection result that is returned by the second terminal in response to the environment detection instruction. The sending the first start instruction to the second terminal includes: sending the first start instruction to the second terminal if the environment detection result indicates that the detection is successful.

The environment detection instruction may be an instruction for instructing to perform environment detection on the second terminal and generate the environment detection result. The environment detection may include, for example, the network environment detection, and/or the installation status detection for the application to be tested. The network environment detection may be understood as detection of a network environment of the second terminal, for example, detection of whether the second terminal is connected to a network and/or whether the network to which the second terminal is connected meets requirements, etc. The installation status detection for the application to be tested may be detection of an installation status of the application to be tested.

Exemplarily, the environment detection instruction may be sent to the second terminal, to instruct, through the environment detection instruction, the attribution test application installed in the second terminal to perform environment detection on the second terminal, the environment detection result returned by the attribution test application may be received, and the first start instruction may be sent to the second terminal when the environment detection result indicates that the detection is successful.

In the above implementation, when the environment detection result indicates the detection has failed, the first start instruction may not be sent to the second terminal, and targeted processing may be performed on a failure item (such as a network environment detection failure and/or the application to be tested being in an uninstalled state) indicated in the environment detection result.

Taking the failure item indicated in the environment detection result being that the application to be tested is in the uninstalled state as an example, the second terminal may be controlled to install the application to be tested.

In some implementations, the second terminal may be controlled to install a preset version of the application to be tested, for example, by sending an installation instruction carrying preset version information to the second terminal, and instructing, through the installation instruction, the second terminal to install the application to be tested whose application version corresponds to the preset version information.

In some other embodiments, the second terminal may be controlled to install a version of the application to be tested that corresponds to the terminal information of the second terminal. For example, target version information of the application to be tested may be determined based on the terminal information of the second terminal, and an installation instruction carrying the target version information may be sent to the second terminal, to instruct, through the installation instruction, the second terminal to install the application to be tested whose application version corresponds to the target version information. In this case, optionally, the environment detection includes the installation status detection for the application to be tested. The attribution test method provided in this embodiment further includes: determining, if the environment detection result indicates that the application to be tested is in an uninstalled state, target version information of the application to be tested based on terminal information of the second terminal, and sending to the second terminal a first installation instruction carrying the target version information, where the first installation instruction is used to instruct the second terminal to install the application to be tested whose application version corresponds to the target version information. The terminal information of the second terminal may be, for example, configuration information of the second terminal, such as hardware configuration information and/or system configuration information of the second terminal. The target version information may be information of a version to be installed of the application to be tested that is determined based on the terminal information of the second terminal. The first installation instruction may be an installation instruction carrying the target version information, and the first installation instruction may be used to instruct the second terminal to install the application to be tested whose application version corresponds to the target version information.

In this embodiment, it is possible to support testing of the attribution solution used for the application to be tested in different test scenarios. The different test scenarios may include, for example, a new-installation scenario, a reinstallation scenario, and/or an update scenario, etc., to meet different test needs of relevant personnel. In this case, optionally, the attribution test result corresponds to a target test scenario. Before the sending an environment detection instruction to the second terminal, the method further comprises: sending a scenario presentation instruction to the second terminal, where the scenario presentation instruction is used to instruct the second terminal to present a scenario identifier of at least one candidate test scenario; and receiving a target scenario identifier that is returned by the second terminal in response to the scenario presentation instruction, where the target scenario identifier is a scenario identifier of the target test scenario, and the target test scenario is a candidate test scenario that is selected by the tester from the at least one candidate test scenario.

The scenario presentation instruction may be an instruction for instructing the second terminal to present the scenario identifier of the at least one candidate test scenario. The candidate test scenario is a test scenario for selection by the tester. The scenario identifier of the candidate test scenario may be used by the tester to trigger selection of a required test scenario. The target scenario identifier may be a scenario identifier selected by the tester. The target test scenario may be a candidate test scenario corresponding to the target scenario identifier.

Exemplarily, the scenario presentation instruction may be sent to the second terminal, to instruct, through the scenario presentation instruction, the second terminal to present the scenario identifier of the at least one candidate test scenario for selection by the tester, the target scenario identifier returned by the second terminal and selected by the tester may be received, and the target test scenario may be determined based on the target scenario identifier, to test the attribution solution for the application to be tested in the target test scenario.

S202: Present attribution prompt information, and/or send an operation prompt instruction to the second terminal, where the operation prompt instruction is used to instruct the second terminal to present the attribution prompt information, the attribution prompt information is used to prompt a tester to perform an attribution operation, and the application to be tested generates the attribution detection result based on the attribution operation.

The attribution prompt information may be information used to prompt the tester to perform the attribution operation, such as execution guidance information for the attribution operation. The attribution operation may be an operation that needs to be performed by the tester during the attribution test, and there may be one or more attribution operations. Exemplarily, the attribution prompt information may be used to guide the tester to perform the attribution operation. For example, different attribution operations may correspond to different attribution prompt information. When attribution operations to be performed are different, different attribution prompt information may be presented.

In this embodiment, the first terminal may present and/or control the second terminal to present the attribution prompt information, to prompt, through the attribution prompt information, the tester to perform the attribution operation, so as to complete the attribution detection for the application to be tested, thereby reducing the occurrence of misoperations during an attribution test and further improving the efficiency and accuracy of the attribution test.

Specifically, after the application to be tested has been started, the first terminal may present the attribution prompt information, and/or send the operation prompt instruction to the second terminal, to instruct, through the operation prompt instruction, the second terminal to present the attribution prompt information, so as to prompt, through the attribution prompt information, the tester to perform the attribution operation.

S203: Receive an attribution detection result that is returned by the second terminal in response to the preset control instruction, where the preset control instruction includes the first start instruction.

S204: Generate, based on the attribution detection result and an expected detection result for the application to be tested, an attribution test result for the application to be tested.

The attribution test solution provided in this embodiment can reduce the occurrence of misoperations during the attribution test and further improve the efficiency and accuracy of the attribution test by prompting, through the attribution prompt information, the tester to perform the attribution operation.

FIG. 3 is a schematic flowchart of an attribution test method according to an embodiment of the present disclosure. The method may be performed by an attribution test apparatus, where the apparatus may be implemented by software and/or hardware, and may be configured in an electronic device, typically, in a mobile phone or a tablet computer, for example, in a second terminal having an application to be tested installed therein. The attribution test method provided in this embodiment of the present disclosure is applicable to scenarios where an attribution solution test is performed, particularly to scenarios where an attribution solution test is performed on a pre-installed application. As shown in FIG. 3, the attribution test method provided in this embodiment may include the following steps.

S301: Perform, in response to a preset control instruction sent by a first terminal, attribution detection on an installation channel of the application to be tested and generating an attribution detection result.

Exemplarily, when the preset control instruction sent by the first terminal is received, attribution detection may be performed, in response to the preset control instruction, on the installation channel of the installed application to be tested, and the attribution detection result may be generated. For example, the application to be tested may be controlled to perform attribution detection on the installation channel by using an attribution solution configured for the application to be tested and the attribution detection result may be generated.

S302: Send the attribution detection result to the first terminal, where the attribution detection result is used by the first terminal to generate an attribution test result.

In this embodiment, after the attribution detection result is generated, the attribution detection result may be sent to the first terminal, so that the first terminal may generate, based on the generated attribution detection result, the attribution test result for the application to be tested.

In some implementations, the attribution detection result is sent by the attribution test application to the first terminal, and before the performing, in response to a preset control instruction sent by a first terminal, attribution detection on an installation channel of the application to be tested and generating an attribution detection result, the method further comprises: performing installation status detection on the attribution test application in response to an installation detection instruction sent by the first terminal, generating an application detection result, and sending the application detection result to the first terminal; installing the attribution test application in response to a second installation instruction sent by the first terminal when the attribution test application is in an uninstalled state; and starting the attribution test application in response to a second start instruction sent by the first terminal when the attribution test application is in an installed state or when the attribution test application has been installed.

In the above implementation, when receiving the installation detection instruction sent by the first terminal, the second terminal may perform installation status detection on the attribution test application in response to the installation detection instruction, to generate the application detection result, and send the application detection result to the first terminal.

Correspondingly, the first terminal may receive the application detection result sent by the second terminal, and send the second installation instruction to the second terminal if the application detection result indicates that the attribution test application is in the uninstalled state, to instruct, through the second installation instruction, the second terminal to install the attribution test application, and send the second start instruction to the second terminal after the attribution test application has been installed; and/or the first terminal may send the second start instruction to the second terminal if the application detection result indicates that the attribution test application is in the installed state.

Therefore, when receiving the second installation instruction sent by the first terminal, the second terminal may install the attribution test application in response to the second installation instruction; and/or when receiving the second start instruction sent by the first terminal, the second terminal may start, in response to the second start instruction, the attribution test application installed in the second terminal.

In some implementations, the second terminal may collect an attribution test image at the local end and send the attribution test image to the first terminal, so that the first terminal may generate the attribution test result including the attribution test image, thereby further improving the comprehensiveness of the generated attribution test result. For example, when a screen recording instruction sent by the first terminal is received, screen recording may be performed in response to the screen recording instruction, to obtain the attribution test image, and the obtained attribution test image may be sent to the first terminal in real time, periodically, or before the first terminal generates the attribution test result. In this case, optionally, the attribution detection result further carries an attribution test image at the second terminal. The attribution test method provided in this embodiment further includes: performing screen recording in response to a screen recording instruction sent by the first terminal, to obtain the attribution test image, and sending the attribution test image to the first terminal.

In some implementations, the second terminal may obtain display position information of the application to be tested at the local end and send the display position information to the first terminal, so that the first terminal may generate the attribution test result including the display position information, thereby further improving the comprehensiveness of the generated attribution test result. Exemplarily, when an information obtaining instruction sent by the first terminal is received, the display position information of the application to be tested at the local end may be obtained in response to the information obtaining instruction. For example, a screenshot may be taken when an application icon of the application to be tested is displayed on the screen, for example, by displaying a window or page where the application icon of the application to be tested is located and taking a screenshot, a picture obtained through screenshotting is used as the display position information of the application to be tested at the local end, and the display position information is sent to the first terminal. In this case, optionally, after the sending the attribution detection result to the first terminal, the method further includes: obtaining display position information of the application to be tested in the second terminal in response to an information obtaining instruction sent by the first terminal, and sending the display position information to the first terminal.

In some implementations, the second terminal may present the attribution test result generated by the first terminal to the tester, so that the attribution test result can be viewed by the tester. For example, when a result presentation instruction sent by the first terminal is received, the attribution test result carried in the result presentation instruction may be obtained through the attribution test application in response to the result presentation instruction, and the attribution test result may be presented. In this case, optionally, after the sending the attribution detection result to the first terminal, the method further includes: presenting, through the attribution test application and in response to a result presentation instruction sent by the first terminal, the attribution test result carried in the result presentation instruction.

In some implementations, the second terminal may report the attribution test result generated by the first terminal. For example, the attribution test application installed in the second terminal may report the attribution test result to a database and/or a server (e.g., an attribution platform) for viewing by a business party of the application to be tested. Exemplarily, when receiving a reporting prompt instruction sent by the first terminal, the attribution test application installed in the first terminal may present reporting prompt information in response to the reporting prompt instruction, where the reporting prompt information is used to prompt the tester to report the generated attribution test result; and when detecting that the tester triggers the reporting prompt information, the attribution test application may report the attribution test result generated by the first terminal. In this case, optionally, after sending the attribution detection result to the first terminal, the method further includes: presenting reporting prompt information through the attribution test application in response to a reporting prompt instruction sent by the first terminal, wherein the reporting prompt information is used to trigger reporting of the attribution test result.

In the attribution test method provided in this embodiment, in response to the preset control instruction sent by the first terminal, attribution detection is performed on the installation channel of the application to be tested and the attribution detection result is generated; and the attribution detection result is sent to the first terminal, where the attribution detection result is used by the first terminal to generate the attribution test result. With the above technical solution, this embodiment can improve the efficiency of an attribution solution test and the accuracy of an attribution solution test result by performing attribution detection and generating the attribution detection result in response to the control of the first terminal during the attribution test process.

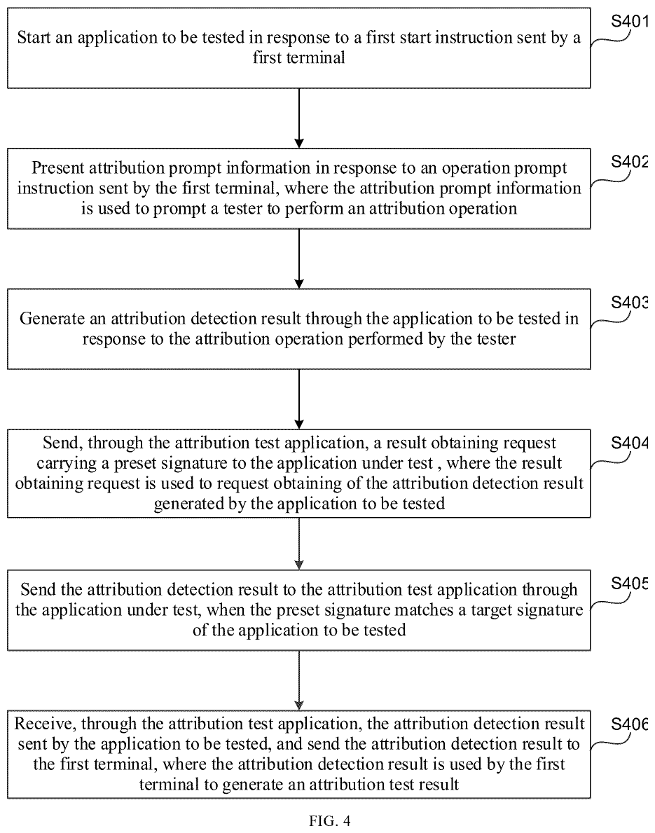

FIG. 4 is a schematic flowchart of another attribution test method according to an embodiment of the present disclosure. The solution in this embodiment may be combined with one or more optional solutions in the above embodiment. Optionally, the preset control instruction comprises a first start instruction, and the performing, in response to a preset control instruction sent by a first terminal, attribution detection on an installation channel of the application to be tested and generating an attribution detection result comprises: starting the application to be tested in response to the first start instruction sent by the first terminal; presenting attribution prompt information in response to an operation prompt instruction sent by the first terminal, wherein the attribution prompt information is used to prompt a tester to perform an attribution operation; and generating the attribution detection result through the application to be tested in response to the attribution operation performed by the tester.

Optionally, the sending the attribution detection result to the first terminal comprises: sending, through the attribution test application, a result obtaining request carrying a preset signature to the application to be tested, wherein the result obtaining request is used to request obtaining of the attribution detection result generated by the application to be tested; sending the attribution detection result to the attribution test application through the application to be tested, when the preset signature matches a target signature of the application to be tested; and receiving, through the attribution test application, the attribution detection result sent by the application to be tested, and sending the attribution detection result to the first terminal.

Accordingly, as shown in FIG. 4, the attribution test method provided in this embodiment may include the following steps.

S401: Start the application to be tested in response to the first start instruction sent by the first terminal.

In this embodiment, when receiving the first start instruction sent by the first terminal, the second terminal may start the application to be tested in response to the first start instruction, so as to facilitate subsequent attribution detection through the application to be tested.

In some implementations, the attribution test application installed in the second terminal may perform environment detection on the second terminal. In this case, optionally, the second terminal further has an attribution test application installed therein, and before the starting the application to be tested in response to the first start instruction sent by the first terminal, the method further comprises: performing environment detection through the attribution test application in response to an environment detection instruction sent by the first terminal, and generating an environment detection result, where the environment detection comprises network environment detection, and/or installation status detection for the application to be tested; and sending the environment detection result to the first terminal through the attribution test application.

Exemplarily, when the environment detection instruction sent by the first terminal is received, the attribution test application installed in the second terminal may perform environment detection on the second terminal in response to the environment detection instruction, for example, performing network environment detection on the second terminal and/or performing installation status detection on the application to be tested, generate the environment detection result, and send the environment detection result to the first terminal.

In the above implementation, after receiving the environment detection result sent by the attribution test application installed in the second terminal, the first terminal may perform subsequent processing based on the environment detection result. Exemplarily, if the environment detection result indicates that the application to be tested is in an uninstalled state, that is, the application to be tested has not been installed in the second terminal, target version information of the application to be tested may be determined based on terminal information of the second terminal, and a first installation instruction carrying the target version information may be sent to the second terminal, where the first installation instruction is used to instruct the second terminal to install the application to be tested whose application version corresponds to the target version information.

Thus, after receiving the first installation instruction sent by the first terminal, the second terminal may parse the first installation instruction, obtain the target version information carried in the first installation instruction, and install the application to be tested whose application version corresponds to the target version information. In this case, optionally, after the sending the environment detection result to the first terminal through the attribution test application, the method further comprises: installing, in response to a first installation instruction sent by the first terminal when the environment detection result indicates that the application to be tested is in an uninstalled state, the application to be tested whose application version corresponds to target version information carried in the first installation instruction.

In some implementations, the attribution test application installed in the second terminal may further present a scenario identifier of at least one candidate test scenario to the tester for the tester to select a scenario (i.e., a target test scenario) for this test. In this case, optionally, the attribution test result corresponds to a target test scenario, and before the performing environment detection through the attribution test application in response to an environment detection instruction sent by the first terminal, the method further comprises: presenting a scenario identifier of at least one candidate test scenario through the attribution test application in response to a scenario presentation instruction sent by the first terminal; and sending a target scenario identifier to the first terminal in response to a selection operation of the tester for the target test scenario from the at least one candidate test scenario, where the target scenario identifier is a scenario identifier of the target test scenario.

The selection operation may be a trigger operation for selecting a candidate test scenario, such as an operation for triggering a scenario identifier of a candidate test scenario.

Exemplarily, after receiving the scenario presentation instruction sent by the first terminal, the attribution test application may present the scenario identifier of the at least one candidate test scenario in response to the scenario presentation instruction. Thus, the tester may trigger the selection of the scenario identifier of the candidate test scenario for this test. Correspondingly, when detecting that the tester triggers a scenario identifier of a candidate test scenario, the attribution test application may determine the scenario identifier triggered by the tester as the scenario identifier of the target test scenario (i.e., the target scenario identifier), determine that a selection operation for the target test scenario has been received, and send the scenario identifier of the target test scenario to the first terminal in response to the selection operation.

S402: Present attribution prompt information in response to an operation prompt instruction sent by the first terminal, where the attribution prompt information is used to prompt a tester to perform an attribution operation.

In this embodiment, when receiving the operation prompt instruction sent by the first terminal, the second terminal may present the attribution prompt information in response to the operation prompt instruction, for example, presenting the attribution prompt information through the application to be tested, where the attribution prompt information is used to prompt the tester to perform the attribution operation.

S403: Generate the attribution detection result through the application to be tested in response to the attribution operation performed by the tester.

In this embodiment, the tester may perform the attribution operation as prompted through the attribution prompt information. Thus, the application to be tested installed in the second terminal may perform attribution detection in response to the attribution operation performed by the tester and by using an attribution solution configured for the application to be tested, and generate the attribution detection result.

S404: Send, through the attribution test application, a result obtaining request carrying a preset signature to the application to be tested, where the result obtaining request is used to request obtaining of the attribution detection result generated by the application to be tested.

In this embodiment, after the application to be tested installed in the second terminal generates the attribution test result, the attribution test application installed in the second terminal may obtain from the application to be tested the attribution test result generated by the application to be tested, so as to send the attribution test result generated by the application to be tested to the first terminal.

Exemplarily, the application to be tested may be configured with a content provider component as a data source. In the content provider component, access control for the content provider component may be identified by a preset field. For example, the access control for the content provider component may be identified by a permission field, and the level of the field may be set to a signature, that is, only applications with the same signature can access the data source, which may avoid access by third-party applications and enhance the data security.

Therefore, when obtaining from the application to be tested the attribution detection result generated by the application to be tested, the attribution test application may generate the result obtaining request carrying the preset signature, and send the result obtaining request to the application to be tested installed in the second terminal.

S405: Send the attribution detection result to the attribution test application through the application to be tested, when the preset signature matches a target signature of the application to be tested.

Exemplarily, after receiving the result obtaining request sent by the attribution test application, the application to be tested installed in the second terminal may parse the result obtaining request to obtain the preset signature carried in the result obtaining request, and determine whether the preset signature is the same as the target signature configured in the content provider component, that is, to determine whether the preset signature matches the target signature. If the preset signature is the same as the target signature, the generated attribution detection result is sent to the attribution test application.

In addition, if the preset signature is not the same as the target signature, the generated attribution detection result may not be sent to the attribution test application. For example, signature prompt information may be sent to the attribution test application, to prompt that the preset signature of the attribution test application does not match the target signature of the application to be tested.

S406: Receive, through the attribution test application, the attribution detection result sent by the application to be tested, and send the attribution detection result to the first terminal, where the attribution detection result is used by the first terminal to generate the attribution test result.

Exemplarily, the attribution test application installed in the second terminal may receive the attribution detection result sent by the application to be tested, and send the attribution detection result to the first terminal, so that the first terminal generates the attribution test result based on the attribution detection result.

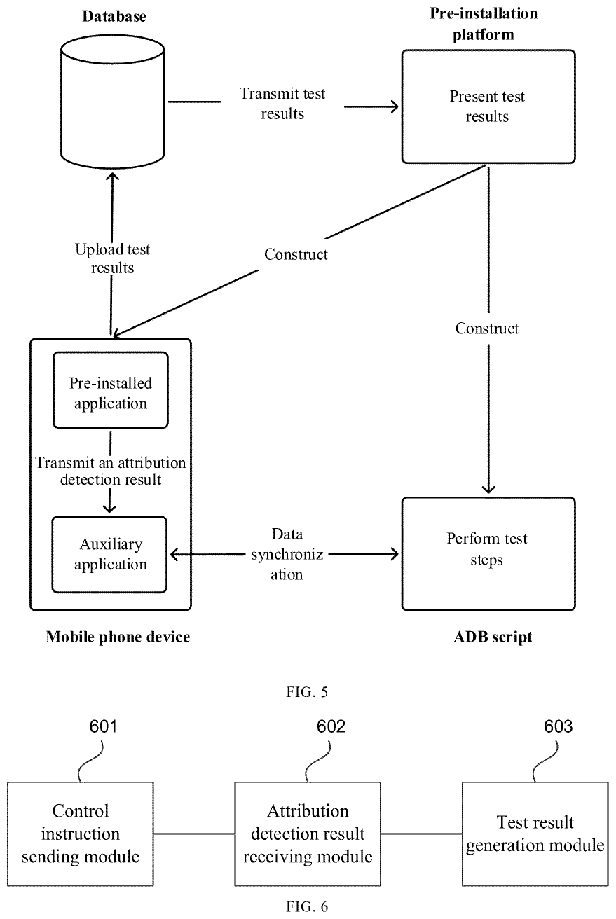

FIG. 5 is a diagram of an architecture of a pre-installation attribution test system according to an embodiment of the present disclosure. Taking a pre-installation attribution test as an example, as shown in FIG. 5, an ADB script may be configured in a first terminal, and a pre-installed application (i.e., an application to be tested) and an auxiliary application (i.e., an attribution test application) may be installed in a second terminal. ADB is a set of command line debugging tools used by a user to debug a device. After connecting a computer (i.e., the first terminal) to a mobile device (i.e., the second terminal), a tester may use the ADB tool to complete page jumping (e.g., switching of content presented on the mobile device), screenshotting, screen recording, and other functions, so as to address the problems in the prior art of test errors caused by non-standard attribution test procedures, a single-dimension attribution result resulting in inability to verify the accuracy of pre-installation in more dimensions, and/or high communication costs during an attribution test process, and lack of archiving management for test results.

Taking a pre-installation attribution test as an example below, an exemplary description of the attribution test method provided in the embodiments of the present disclosure is made.

As shown in FIG. 5, the pre-installation attribution test system as a whole may be divided into three components. An ADB script, which may produce a Java archive (JAR) package and may be responsible for executing ADB commands. Main functions thereof include environment detection (e.g., controlling a mobile device to perform environment detection), automation of test procedures, pre-installation decision-making (e.g., determining target version information), pre-installation result (e.g., attribution detection result) collection, and visual pre-installation collection (e.g., display position information and/or attribution test image), and other aspects. An auxiliary application, which may produce a traditional Android application package (APK), and provides a tester with a visual interface, including UI interaction in a test procedure and presentation of test results (i.e., attribution test results), as well as collection of some device information (e.g., attribution detection results), and uploading of the test results (e.g., the attribution test results) to a background database. A pre-installation platform (i.e., a server), which is responsible for automated construction of test suites (e.g., the pre-installed application, the auxiliary application, and the ADB script) as well as the presentation and archiving of the test results.

Exemplarily, the overall procedure of the attribution test method provided in the embodiments of the present disclosure may include four main stages: environment detection, pre-installation information collection, information verification (e.g., verification of an attribution detection result and generation of an attribution test result), and information archiving. The specific execution order of the procedure is described as follows.

A1. The computer executes the ADB script, and the ADB script detects whether the auxiliary application is installed in the mobile device, and if not, automatically controls the mobile device to complete installation of the auxiliary application.

A2. The ADB script controls the mobile device to start the auxiliary application and initiate automatic screen recording.

A3. The tester selects a scenario for test (e.g., the ADB script controls the mobile device to present a scenario identifier of at least one candidate test scenario for selection by the tester).

A4. The ADB script controls the auxiliary application to perform environment detection on the mobile device, and when determining through detection that the pre-installed application installed is not installed in the mobile device, makes a pre-installation decision to determine target version information of the pre-installed application, and controls the mobile device to install the pre-installed application based on the target version information.

A5. The ADB script automatically starts the pre-installed application, guides the tester to complete a guidance procedure (i.e., prompting the tester to perform an attribution operation through presented attribution prompt information), and collects an attribution result (i.e., the attribution detection result).

A6. The ADB script obtains a screenshot file, such as of the position (i.e., display position information) of the pre-installed application, and generates a test result (i.e., the attribution test result).

A7. The ADB script automatically controls the auxiliary application to present the test result, including the attribution result and the test page (e.g., the screenshot file of the display position information).

A8. The ADB script controls the auxiliary application to guide the tester to upload the currently generated test result.

The collection and transmission of pre-installation attribution information (i.e., the attribution detection result) may be performed in the following manner. The pre-installed application is configured with a content provider as a data source, in which a permission field represents access control for a provider, and the level of the field is set to a signature, that is, only applications with the same signature may access the data source, which can prevent third-party access and enhance the data security. The auxiliary application may return required information during a query by accessing the content provider. The information may include, but is not limited to, a channel number of pre-installation cooperation, a sub-channel number of the pre-installation cooperation, a first installation time of the pre-installed application and/or a pre-installed version number of the pre-installed application, etc., which may be specifically set as required.

The ADB script may access and add data to the auxiliary application through an ADB command adb content, that is, to implement data synchronization with the auxiliary application:
Access data: adb shell content query—uri {provider_name}.
Add data: abd shell content insert—uri {provider_name}—bind {data}.

In this way, the embodiments of the present disclosure propose a complete set of pre-installation result testing solutions, which integrates functions of pre-installation result collection, result verification, test archiving, etc., effectively improving the efficiency of pre-installation result testing, etc., and may implement data transmission at the script side and the application side through client development technologies such as ADB and content provider, reducing failures in attribution testing caused by misoperations, providing more diversified test result collection requirements, providing functions of collecting key pages by means of screenshotting and screen recording, etc., and providing a function of reporting a test result, supporting a business party of the pre-installed application to view the test result in real time, and greatly reducing communication costs.

In the attribution test method provided in this embodiment, the attribution prompt information is presented and access permission is controlled through a signature, which can reduce the occurrence of misoperations during an attribution test and improve the efficiency and accuracy of the attribution test and the security of data during access.

FIG. 6 is a block diagram of a structure of an attribution test apparatus according to an embodiment of the present disclosure. The apparatus may be implemented by software and/or hardware, and may be configured in an electronic device, typically, in a computer, for example, in a first terminal. The apparatus may be suitable for performing attribution solution testing by performing an attribution test method, such as for performing attribution solution testing on a pre-installed application. As shown in FIG. 6, the attribution test apparatus provided in this embodiment may include: a control instruction sending module 601, an attribution detection result receiving module 602, and a test result generation module 603.

The control instruction sending module 601 is configured to send a preset control instruction to a second terminal, wherein the preset control instruction is used to instruct the second terminal to perform attribution detection on an installation channel of an application to be tested and generate an attribution detection result, and the application to be tested is installed in the second terminal.

The attribution detection result receiving module 602 is configured to receive the attribution detection result that is returned by the second terminal in response to the preset control instruction.

The test result generation module 603 is configured to generate, based on the attribution detection result and an expected detection result for the application to be tested, an attribution test result for the application to be tested.

In the attribution test apparatus provided in this embodiment, the control instruction sending module sends the preset control instruction to the second terminal, where the preset control instruction is used to instruct the second terminal to perform attribution detection on the installation channel of the application to be tested and generate the attribution detection result, and the application to be tested is installed in the second terminal; the attribution detection result receiving module receives the attribution detection result that is returned by the second terminal in response to the preset control instruction; and the test result generation module generates, based on the attribution detection result and the expected detection result for the application to be tested, the attribution test result for the application to be tested. With the above technical solution, this embodiment can improve the efficiency of an attribution solution test and the accuracy of an attribution solution test result by controlling, through the first terminal, the second terminal to test an attribution solution used for the application to be tested.

Optionally, the preset control instruction includes a first start instruction. The control instruction sending module 601 includes: a start instruction sending unit configured to send the first start instruction to the second terminal, where the first start instruction is used to instruct the second terminal to start the application to be tested; and a prompt information presentation unit configured to present attribution prompt information, and/or send an operation prompt instruction to the second terminal, where the operation prompt instruction is used to instruct the second terminal to present the attribution prompt information, the attribution prompt information is used to prompt a tester to perform an attribution operation, and the application to be tested generates the attribution detection result based on the attribution operation.

Further, the attribution test apparatus provided in this embodiment may further include: a detection instruction sending module configured to, before the sending the first start instruction to the second terminal, send an environment detection instruction to the second terminal, where the environment detection instruction is used to instruct an attribution test application to perform environment detection on the second terminal and generate an environment detection result, the attribution test application is installed in the second terminal, and the environment detection comprises network environment detection, and/or installation status detection for the application to be tested; and an environment detection result receiving module configured to receive the environment detection result that is returned by the second terminal in response to the environment detection instruction. The start instruction sending unit may be configured to: send the first start instruction to the second terminal if the environment detection result indicates that the detection is successful.

Optionally, the environment detection includes the installation status detection for the application to be tested. The attribution test apparatus provided in this embodiment may further include: a first installation instruction sending module configured to determine, if the environment detection result indicates that the application to be tested is in an uninstalled state, target version information of the application to be tested based on terminal information of the second terminal, and send to the second terminal a first installation instruction carrying the target version information, where the first installation instruction is used to instruct the second terminal to install the application to be tested whose application version corresponds to the target version information.

Optionally, the attribution test result corresponds to a target test scenario. The attribution test apparatus provided in this embodiment may further include: a scenario presentation instruction sending module configured to, before the sending an environment detection instruction to the second terminal, send a scenario presentation instruction to the second terminal, where the scenario presentation instruction is used to instruct the second terminal to present a scenario identifier of at least one candidate test scenario; and a scenario identifier receiving module configured to receive a target scenario identifier that is returned by the second terminal in response to the scenario presentation instruction, where the target scenario identifier is a scenario identifier of the target test scenario, and the target test scenario is a candidate test scenario that is selected by the tester from the at least one candidate test scenario.

Further, the attribution test apparatus provided in this embodiment may further include: an information obtaining instruction sending module configured to, after the receiving the attribution detection result that is returned by the second terminal in response to the preset control instruction, send an information obtaining instruction to the second terminal, and receive display position information that is returned by the second terminal in response to the information obtaining instruction, where the display position information is used to indicate a display position of the application to be tested in the second terminal. The test result generation module 603 may be configured to: generate, based on the attribution detection result, the expected detection result for the application to be tested, and the display position information, the attribution test result for the application to be tested.

Further, the attribution test apparatus provided in this embodiment may further include: a result presentation instruction sending module configured to, after the generating, based on the attribution detection result and an expected detection result for the application to be tested, an attribution test result for the application to be tested, send to the second terminal a result presentation instruction carrying the attribution test result, where the result presentation instruction is used to instruct the second terminal to present the attribution test result; and a reporting prompt instruction sending module configured to, after the generating, based on the attribution detection result and an expected detection result for the application to be tested, an attribution test result for the application to be tested, send a reporting prompt instruction to the second terminal, where the reporting prompt instruction is used to instruct the second terminal to present reporting prompt information, and the reporting prompt information is used to trigger reporting of the attribution test result.

Optionally, the attribution detection result is sent by the second terminal through the attribution test application. The attribution test apparatus provided in this embodiment may further include: an application detection instruction sending module configured to, before the sending a preset control instruction to a second terminal, send an application detection instruction to the second terminal, and receive an application detection result that is returned by the second terminal in response to the application detection instruction, where the application detection instruction is used to instruct the second terminal to perform installation status detection on the attribution test application; a start instruction sending module configured to send a second start instruction to the second terminal if the application detection result indicates that the attribution test application is in an installed state, where the second start instruction is used to instruct the second terminal to start the attribution test application; and a second installation instruction sending module configured to send a second installation instruction to the second terminal if the application detection result indicates that the attribution test application is in an uninstalled state, and send the second start instruction to the second terminal after the attribution test application has been installed, where the second installation instruction is used to instruct the second terminal to install the attribution test application.

Optionally, the attribution detection result further carries an attribution test image at the second terminal. The attribution test apparatus provided in this embodiment may further include: a screen recording instruction sending module configured to, before the sending a preset control instruction to a second terminal, send a screen recording instruction to the second terminal, where the screen recording instruction is used to instruct the second terminal to perform screen recording, to obtain the attribution test image at the second terminal; and an image receiving module configured to, before the generating, based on the attribution detection result and an expected detection result for the application to be tested, an attribution test result for the application to be tested, receive the attribution test image that is returned by the second terminal in response to the screen recording instruction.

The attribution test apparatus provided in this embodiment of the present disclosure may perform the attribution test method provided in any of the embodiments of the present disclosure, and has corresponding functional modules and beneficial effects for performing the attribution test method. For technical details not described in detail in this embodiment, reference may be made to the attribution test method provided in any of the embodiments of the present disclosure.

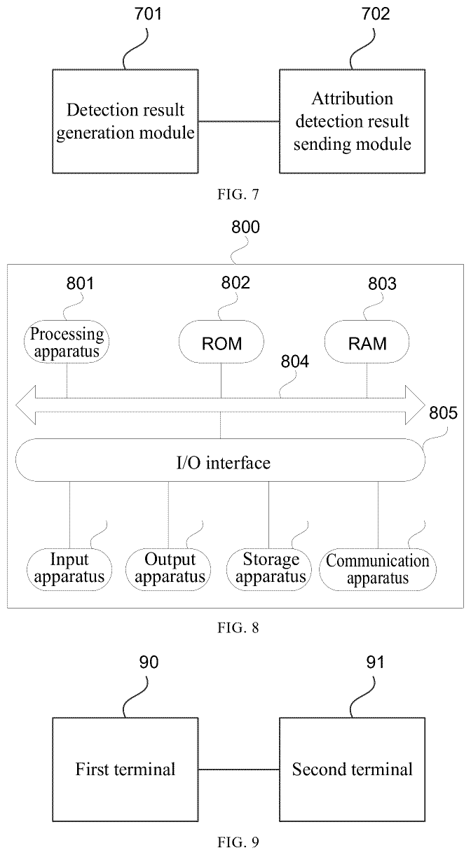

FIG. 7 is a block diagram of a structure of an attribution test apparatus according to an embodiment of the present disclosure. The apparatus may be implemented by software and/or hardware, and may be configured in an electronic device, typically, in a mobile phone or a tablet computer, for example, in a second terminal having an application to be tested installed therein. The apparatus may be suitable for performing an attribution solution test by performing an attribution test method, such as for performing an attribution solution test on a pre-installed application. As shown in FIG. 7, the attribution test apparatus provided in this embodiment may include: a detection result generation module 701 and an attribution detection result sending module 702.

The detection result generation module 701 is configured to perform, in response to a preset control instruction sent by a first terminal, attribution detection on an installation channel of the application to be tested and generate an attribution detection result.

The attribution detection result sending module 702 is configured to send the attribution detection result to the first terminal, where the attribution detection result is used by the first terminal to generate an attribution test result.

In the attribution test apparatus provided in this embodiment, in response to the preset control instruction sent by the first terminal, the detection result generation module performs attribution detection on the installation channel of the application to be tested and generates the attribution detection result; and the attribution detection result sending module sends the attribution detection result to the first terminal, where the attribution detection result is used by the first terminal to generate the attribution test result. With the above technical solution, this embodiment can improve the efficiency of an attribution solution test and the accuracy of an attribution solution test result by performing attribution detection and generating the attribution detection result in response to the control of the first terminal during the attribution test process.

Optionally, the preset control instruction includes a first start instruction. The detection result generation module 701 may include: an application start unit configured to start the application to be tested in response to the first start instruction sent by the first terminal; a prompt information presentation unit configured to present attribution prompt information in response to an operation prompt instruction sent by the first terminal, where the attribution prompt information is used to prompt a tester to perform an attribution operation; and a detection result generation unit configured to generate the attribution detection result through the application to be tested in response to the attribution operation performed by the tester.

Optionally, the second terminal further has an attribution test application installed therein. The attribution test apparatus provided in this embodiment may further include: an environment detection module configured to, before the starting the application to be tested in response to the first start instruction sent by the first terminal, perform environment detection through the attribution test application in response to an environment detection instruction sent by the first terminal, and generate an environment detection result, where the environment detection includes network environment detection, and/or installation status detection for the application to be tested; and an environment attribution detection result sending module configured to send the environment detection result to the first terminal through the attribution test application.

Further, the attribution test apparatus provided in this embodiment may further include: an application to be tested installing module configured to, after the sending the environment detection result to the first terminal through the attribution test application, install, in response to a first installation instruction sent by the first terminal when the environment detection result indicates that the application to be tested is in an uninstalled state, the application to be tested whose application version corresponds to target version information carried in the first installation instruction.

Optionally, the attribution test result corresponds to a target test scenario. The attribution test apparatus provided in this embodiment may further include: a scenario identifier presentation module configured to, before the performing environment detection through the attribution test application in response to an environment detection instruction sent by the first terminal, present a scenario identifier of at least one candidate test scenario through the attribution test application in response to a scenario presentation instruction sent by the first terminal; and a scenario identifier sending module configured to send a target scenario identifier to the first terminal in response to a selection operation of the tester for the target test scenario from the at least one candidate test scenario, where the target scenario identifier is a scenario identifier of the target test scenario.

Further, the attribution test apparatus provided in this embodiment may further include: a position information obtaining module configured to, after the sending the attribution detection result to the first terminal, obtain display position information of the application to be tested in the second terminal in response to an information obtaining instruction sent by the first terminal, and send the display position information to the first terminal; a result presentation module configured to, after the sending the attribution detection result to the first terminal, present, through the attribution test application and in response to a result presentation instruction sent by the first terminal, the attribution test result carried in the result presentation instruction; and a reporting prompt module configured to, after the sending the attribution detection result to the first terminal, present reporting prompt information through the attribution test application in response to a reporting prompt instruction sent by the first terminal, where the reporting prompt information is used to trigger reporting of the attribution test result.

Optionally, the attribution detection result sending module 702 includes: a result obtaining unit configured to send, through the attribution test application, a result obtaining request carrying a preset signature to the application to be tested, wherein the result obtaining request is used to request obtaining of the attribution detection result generated by the application to be tested; a first result sending unit configured to send the attribution detection result to the attribution test application through the application to be tested, when the preset signature matches a target signature of the application to be tested; and a second result sending unit configured to receive, through the attribution test application, the attribution detection result sent by the application to be tested, and sending the attribution detection result to the first terminal.

Optionally, the attribution detection result is sent by the attribution test application to the first terminal. The attribution test apparatus provided in this embodiment may further include: a status detection module configured to, before the performing, in response to a preset control instruction sent by a first terminal, attribution detection on an installation channel of the application to be tested and generating an attribution detection result, perform installation status detection on the attribution test application in response to an installation detection instruction sent by the first terminal, generate an application detection result, and send the application detection result to the first terminal; an attribution test application installation module configured to install the attribution test application in response to a second installation instruction that is sent by the first terminal when the attribution test application is in an uninstalled state; and an attribution test application start module configured to start the attribution test application in response to a second start instruction sent by the first terminal when the attribution test application is in an installed state or when the attribution test application has been installed.

Optionally, the attribution detection result further carries an attribution test image at the second terminal. The attribution test apparatus provided in this embodiment may further include: a screen recording module configured to perform screen recording in response to a screen recording instruction sent by the first terminal, to obtain the attribution test image, and send the attribution test image to the first terminal.

The attribution test apparatus provided in this embodiment of the present disclosure may perform the attribution test method provided in any of the embodiments of the present disclosure, and has corresponding functional modules and beneficial effects for performing the attribution test method. For technical details not described in detail in this embodiment, reference may be made to the attribution test method provided in any of the embodiments of the present disclosure.

FIG. 8 is a schematic diagram of a structure of an electronic device (for example, a terminal device) 800 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: send a preset control instruction to a second terminal, wherein the preset control instruction is used to instruct the second terminal to perform attribution detection on an installation channel of an application to be tested and generate an attribution detection result, and the application to be tested is installed in the second terminal; receive the attribution detection result that is returned by the second terminal in response to the preset control instruction; and generate, based on the attribution detection result and an expected detection result for the application to be tested, an attribution test result for the application to be tested; or perform, in response to a preset control instruction sent by a first terminal, attribution detection on an installation channel of the application to be tested and generate an attribution detection result; and send the attribution detection result to the first terminal, wherein the attribution detection result is used by the first terminal to generate an attribution test result.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

FIG. 9 is a schematic diagram of a structure of an attribution test system according to an embodiment of the present disclosure. The attribution test system provided in this embodiment of the present disclosure is applicable to scenarios where an attribution solution test is performed, particularly to scenarios where an attribution solution test is performed on a pre-installed application. As shown in FIG. 9, the attribution test system provided in this embodiment may include a first terminal 90 and a second terminal 91, the second terminal 91 having an application to be tested installed therein.

The first terminal 90 sends a preset control instruction to the second terminal 91.

The second terminal 91 performs, in response to the preset control instruction sent by the first terminal 90, attribution detection on an installation channel of the application to be tested, generates an attribution detection result, and sends the attribution detection result to the first terminal 90.

The first terminal 90 receives the attribution detection result sent by the second terminal 91, and generates, based on the attribution detection result and an expected detection result for the application to be tested, an attribution test result for the application to be tested.

In the attribution test system provided in this embodiment, the first terminal sends the preset control instruction to the second terminal; the second terminal performs, in response to the preset control instruction sent by the first terminal, attribution detection on the installation channel of the application to be tested, generates the attribution detection result, and sends the attribution detection result to the first terminal; and the first terminal receives the attribution detection result sent by the second terminal, and generates, based on the attribution detection result and the expected detection result for the application to be tested, the attribution test result for the application to be tested. With the above technical solution, this embodiment can improve the efficiency of an attribution solution test and the accuracy of an attribution solution test result by controlling, through the first terminal, the second terminal to test an attribution solution used for the application to be tested.

According to one or more embodiments of the present disclosure, Example 1 provides an attribution test method, which is applied to a first terminal. The method includes:
sending a preset control instruction to a second terminal, wherein the preset control instruction is used to instruct the second terminal to perform attribution detection on an installation channel of an application to be tested and generate an attribution detection result, and the application to be tested is installed in the second terminal;
receiving the attribution detection result that is returned by the second terminal in response to the preset control instruction; and
generating, based on the attribution detection result and an expected detection result for the application to be tested, an attribution test result for the application to be tested.

According to one or more embodiments of the present disclosure, Example 2 provides the method according to Example 1, where the preset control instruction includes a first start instruction, and the sending a preset control instruction to a second terminal includes:
sending the first start instruction to the second terminal, wherein the first start instruction is used to instruct the second terminal to start the application to be tested; and
presenting attribution prompt information, and/or sending an operation prompt instruction to the second terminal, wherein the operation prompt instruction is used to instruct the second terminal to present the attribution prompt information, the attribution prompt information is used to prompt a tester to perform an attribution operation, and the application to be tested generates the attribution detection result based on the attribution operation.

According to one or more embodiments of the present disclosure, Example 3 provides the method according to Example 2, where before the sending the first start instruction to the second terminal, the method further includes:
sending an environment detection instruction to the second terminal, wherein the environment detection instruction is used to instruct an attribution test application to perform environment detection on the second terminal and generate an environment detection result, the attribution test application is installed in the second terminal, and the environment detection comprises network environment detection, and/or installation status detection for the application to be tested; and
receiving the environment detection result that is returned by the second terminal in response to the environment detection instruction.

The sending the first start instruction to the second terminal includes:
sending the first start instruction to the second terminal if the environment detection result indicates that the detection is successful.

According to one or more embodiments of the present disclosure, Example 4 provides the method according to Example 3, where the environment detection includes the installation status detection for the application to be tested, and the method further includes:
determining, if the environment detection result indicates that the application to be tested is in an uninstalled state, target version information of the application to be tested based on terminal information of the second terminal, and sending to the second terminal a first installation instruction carrying the target version information, wherein the first installation instruction is used to instruct the second terminal to install the application to be tested whose application version corresponds to the target version information.

According to one or more embodiments of the present disclosure, Example 5 provides the method according to Example 3, where the attribution test result corresponds to a target test scenario, and before the sending an environment detection instruction to the second terminal, the method further comprises:
sending a scenario presentation instruction to the second terminal, wherein the scenario presentation instruction is used to instruct the second terminal to present a scenario identifier of at least one candidate test scenario; and
receiving a target scenario identifier that is returned by the second terminal in response to the scenario presentation instruction, wherein the target scenario identifier is a scenario identifier of the target test scenario, and the target test scenario is a candidate test scenario that is selected by the tester from the at least one candidate test scenario.

According to one or more embodiments of the present disclosure, Example 6 provides the method according to Example 1, where after the receiving the attribution detection result that is returned by the second terminal in response to the preset control instruction, the method further includes:
sending an information obtaining instruction to the second terminal, and receiving display position information that is returned by the second terminal in response to the information obtaining instruction, wherein the display position information is used to indicate a display position of the application to be tested in the second terminal; and
the generating, based on the attribution detection result and an expected detection result for the application to be tested, an attribution test result for the application to be tested comprises:
generating, based on the attribution detection result, the expected detection result for the application to be tested, and the display position information, the attribution test result for the application to be tested.

According to one or more embodiments of the present disclosure, Example 7 provides the method according to Example 1, where after the generating, based on the attribution detection result and an expected detection result for the application to be tested, an attribution test result for the application to be tested, the method further comprises at least one of the following:
sending to the second terminal a result presentation instruction carrying the attribution test result, wherein the result presentation instruction is used to instruct the second terminal to present the attribution test result; and
sending a reporting prompt instruction to the second terminal, wherein the reporting prompt instruction is used to instruct the second terminal to present reporting prompt information, and the reporting prompt information is used to trigger reporting of the attribution test result.

According to one or more embodiments of the present disclosure, Example 8 provides the method according to any one of Examples 1 to 7, where the attribution detection result is sent by the second terminal through the attribution test application, and before the sending a preset control instruction to a second terminal, the method further includes:
sending an application detection instruction to the second terminal, and receiving an application detection result that is returned by the second terminal in response to the application detection instruction, wherein the application detection instruction is used to instruct the second terminal to perform installation status detection on the attribution test application; and
sending a second start instruction to the second terminal if the application detection result indicates that the attribution test application is in an installed state, wherein the second start instruction is used to instruct the second terminal to start the attribution test application; or
sending a second installation instruction to the second terminal if the application detection result indicates that the attribution test application is in an uninstalled state, and sending the second start instruction to the second terminal after the attribution test application has been installed, wherein the second installation instruction is used to instruct the second terminal to install the attribution test application.

According to one or more embodiments of the present disclosure, Example 9 provides the method according to any one of Examples 1 to 7, where the attribution detection result further carries an attribution test image at the second terminal, and before the sending a preset control instruction to a second terminal, the method further comprises:
sending a screen recording instruction to the second terminal, wherein the screen recording instruction is used to instruct the second terminal to perform screen recording, to obtain the attribution test image at the second terminal; and
before the generating, based on the attribution detection result and an expected detection result for the application to be tested, an attribution test result for the application to be tested, the method further comprises:
receiving the attribution test image that is returned by the second terminal in response to the screen recording instruction.

According to one or more embodiments of the present disclosure, Example 10 provides an attribution test method, which is applied to a second terminal, the second terminal having an application to be tested installed therein, the method including:
performing, in response to a preset control instruction sent by a first terminal, attribution detection on an installation channel of the application to be tested and generating an attribution detection result; and
sending the attribution detection result to the first terminal, wherein the attribution detection result is used by the first terminal to generate an attribution test result.

According to one or more embodiments of the present disclosure, Example 11 provides the method according to Example 10, where the preset control instruction comprises a first start instruction, and the performing, in response to a preset control instruction sent by a first terminal, attribution detection on an installation channel of the application to be tested and generating an attribution detection result comprises:
starting the application to be tested in response to the first start instruction sent by the first terminal;
presenting attribution prompt information in response to an operation prompt instruction sent by the first terminal, wherein the attribution prompt information is used to prompt a tester to perform an attribution operation; and
generating the attribution detection result through the application to be tested in response to the attribution operation performed by the tester.

According to one or more embodiments of the present disclosure, Example 12 provides the method according to Example 11, where the second terminal further has an attribution test application installed therein, and before the starting the application to be tested in response to the first start instruction sent by the first terminal, the method further comprises:
performing environment detection through the attribution test application in response to an environment detection instruction sent by the first terminal, and generating an environment detection result, wherein the environment detection comprises network environment detection, and/or installation status detection for the application to be tested; and
sending the environment detection result to the first terminal through the attribution test application.

According to one or more embodiments of the present disclosure, Example 13 provides the method according to Example 12, where after the sending the environment detection result to the first terminal through the attribution test application, the method further comprises:
installing, in response to a first installation instruction sent by the first terminal when the environment detection result indicates that the application to be tested is in an uninstalled state, the application to be tested whose application version corresponds to target version information carried in the first installation instruction.

According to one or more embodiments of the present disclosure, Example 14 provides the method according to Example 12, where the attribution test result corresponds to a target test scenario, and before the performing environment detection through the attribution test application in response to an environment detection instruction sent by the first terminal, the method further comprises:
presenting a scenario identifier of at least one candidate test scenario through the attribution test application in response to a scenario presentation instruction sent by the first terminal; and
sending a target scenario identifier to the first terminal in response to a selection operation of the tester for the target test scenario from the at least one candidate test scenario, wherein the target scenario identifier is a scenario identifier of the target test scenario.

According to one or more embodiments of the present disclosure, Example 15 provides the method according to Example 10, where after the sending the attribution detection result to the first terminal, the method further includes at least one of the following:
obtaining display position information of the application to be tested in the second terminal in response to an information obtaining instruction sent by the first terminal, and sending the display position information to the first terminal;
presenting, through the attribution test application and in response to a result presentation instruction sent by the first terminal, the attribution test result carried in the result presentation instruction; and
presenting reporting prompt information through the attribution test application in response to a reporting prompt instruction sent by the first terminal, wherein the reporting prompt information is used to trigger reporting of the attribution test result.

According to one or more embodiments of the present disclosure, Example 16 provides the method according to any one of Examples 10 to 15, where the sending the attribution detection result to the first terminal includes:
sending, through the attribution test application, a result obtaining request carrying a preset signature to the application to be tested, wherein the result obtaining request is used to request obtaining of the attribution detection result generated by the application to be tested;
sending the attribution detection result to the attribution test application through the application to be tested, when the preset signature matches a target signature of the application to be tested; and
receiving, through the attribution test application, the attribution detection result sent by the application to be tested, and sending the attribution detection result to the first terminal.

According to one or more embodiments of the present disclosure, Example 17 provides the method according to any one of Examples 10 to 15, where the attribution detection result is sent by the attribution test application to the first terminal, and before the performing, in response to a preset control instruction sent by a first terminal, attribution detection on an installation channel of the application to be tested and generating an attribution detection result, the method further comprises:
performing installation status detection on the attribution test application in response to an installation detection instruction sent by the first terminal, generating an application detection result, and sending the application detection result to the first terminal;
installing the attribution test application in response to a second installation instruction sent by the first terminal when the attribution test application is in an uninstalled state; and
starting the attribution test application in response to a second start instruction sent by the first terminal when the attribution test application is in an installed state or when the attribution test application has been installed.

According to one or more embodiments of the present disclosure, Example 18 provides the method according to any one of Examples 10 to 15, where the attribution detection result further carries an attribution test image at the second terminal, and the method further includes:
performing screen recording in response to a screen recording instruction sent by the first terminal, to obtain the attribution test image, and sending the attribution test image to the first terminal.

According to one or more embodiments of the present disclosure, Example 19 provides an attribution test apparatus, which is configured in a first terminal. The apparatus includes:
a control instruction sending module configured to send a preset control instruction to a second terminal, wherein the preset control instruction is used to instruct the second terminal to perform attribution detection on an installation channel of an application to be tested and generate an attribution detection result, and the application to be tested is installed in the second terminal;
an attribution detection result receiving module configured to receive the attribution detection result that is returned by the second terminal in response to the preset control instruction; and
a test result generation module configured to generate, based on the attribution detection result and an expected detection result for the application to be tested, an attribution test result for the application to be tested.

According to one or more embodiments of the present disclosure, Example 20 provides an attribution test apparatus, which is configured in a second terminal, the second terminal having an application to be tested installed therein. The apparatus includes:
a detection result generation module configured to perform, in response to a preset control instruction sent by a first terminal, attribution detection on an installation channel of the application to be tested and generate an attribution detection result; and
an attribution detection result sending module configured to send the attribution detection result to the first terminal, wherein the attribution detection result is used by the first terminal to generate an attribution test result.

According to one or more embodiments of the present disclosure, Example 21 provides an electronic device, including:
one or more processors; and
a memory configured to store one or more programs, where
where the one or more programs, when executed by the one or more processors, cause the one or more processors to implement the attribution test method according to any one of Examples 1 to 18.

According to one or more embodiments of the present disclosure, Example 22 provides a computer-readable storage medium having a computer program stored thereon, where the computer program, when executed by a processor, causes the attribution test method according to any one of Examples 1 to 18 to be implemented.

According to one or more embodiments of the present disclosure, Example 23 provides an attribution test system, including a first terminal and a second terminal, the second terminal having an application to be tested installed therein, where
the first terminal sends a preset control instruction to the second terminal;
the second terminal performs, in response to the preset control instruction sent by the first terminal, attribution detection on an installation channel of the application to be tested, generates an attribution detection result, and sends the attribution detection result to the first terminal; and
the first terminal receives the attribution detection result sent by the second terminal, and generates, based on the attribution detection result and an expected detection result for the application to be tested, an attribution test result for the application to be tested.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An attribution test method, applied to a first terminal, the method comprising:
sending a preset control instruction to a second terminal, wherein the preset control instruction is used to instruct the second terminal to perform attribution detection on an installation channel of an application to be tested and generate an attribution detection result, and the application to be tested is installed in the second terminal;
receiving the attribution detection result that is returned by the second terminal in response to the preset control instruction; and
generating, based on the attribution detection result and an expected detection result for the application to be tested, an attribution test result for the application to be tested.

2. The method according to claim 1, wherein the preset control instruction comprises a first start instruction, and the sending a preset control instruction to a second terminal comprises:
sending the first start instruction to the second terminal, wherein the first start instruction is used to instruct the second terminal to start the application to be tested; and
presenting attribution prompt information, and/or sending an operation prompt instruction to the second terminal, wherein the operation prompt instruction is used to instruct the second terminal to present the attribution prompt information, the attribution prompt information is used to prompt a tester to perform an attribution operation, and the application to be tested generates the attribution detection result based on the attribution operation.

3. The method according to claim 2, wherein before the sending the first start instruction to the second terminal, the method further comprises:
sending an environment detection instruction to the second terminal, wherein the environment detection instruction is used to instruct an attribution test application to perform environment detection on the second terminal and generate an environment detection result, the attribution test application is installed in the second terminal, and the environment detection comprises network environment detection, and/or installation status detection for the application to be tested; and
receiving the environment detection result that is returned by the second terminal in response to the environment detection instruction; and
wherein the sending the first start instruction to the second terminal comprises:
sending the first start instruction to the second terminal in response to the environment detection result indicating that the detection is successful.

4. The method according to claim 3, wherein the environment detection comprises the installation status detection for the application to be tested, and the method further comprises:
determining, in response to the environment detection result indicating that the application to be tested is in an uninstalled state, target version information of the application to be tested based on terminal information of the second terminal, and sending to the second terminal a first installation instruction carrying the target version information, wherein the first installation instruction is used to instruct the second terminal to install the application to be tested whose application version corresponds to the target version information.

5. The method according to claim 3, wherein the attribution test result corresponds to a target test scenario, and before the sending an environment detection instruction to the second terminal, the method further comprises:
sending a scenario presentation instruction to the second terminal, wherein the scenario presentation instruction is used to instruct the second terminal to present a scenario identifier of at least one candidate test scenario; and
receiving a target scenario identifier that is returned by the second terminal in response to the scenario presentation instruction, wherein the target scenario identifier is a scenario identifier of the target test scenario, and the target test scenario is a candidate test scenario that is selected by the tester from the at least one candidate test scenario.

6. The method according to claim 1, wherein after the receiving the attribution detection result that is returned by the second terminal in response to the preset control instruction, the method further comprises:
sending an information obtaining instruction to the second terminal, and receiving display position information that is returned by the second terminal in response to the information obtaining instruction, wherein the display position information is used to indicate a display position of the application to be tested in the second terminal; and
wherein the generating, based on the attribution detection result and an expected detection result for the application to be tested, an attribution test result for the application to be tested comprises:
generating, based on the attribution detection result, the expected detection result for the application to be tested, and the display position information, the attribution test result for the application to be tested.

7. The method according to claim 1, wherein after the generating, based on the attribution detection result and an expected detection result for the application to be tested, an attribution test result for the application to be tested, the method further comprises at least one of the following:
sending to the second terminal a result presentation instruction carrying the attribution test result, wherein the result presentation instruction is used to instruct the second terminal to present the attribution test result; and
sending a reporting prompt instruction to the second terminal, wherein the reporting prompt instruction is used to instruct the second terminal to present reporting prompt information, and the reporting prompt information is used to trigger reporting of the attribution test result.

8. The method according to claim 1, wherein the attribution detection result is sent by the second terminal through the attribution test application, and before the sending a preset control instruction to a second terminal, the method further comprises:
sending an application detection instruction to the second terminal, and receiving an application detection result that is returned by the second terminal in response to the application detection instruction, wherein the application detection instruction is used to instruct the second terminal to perform installation status detection on the attribution test application;
sending a second start instruction to the second terminal in response to the application detection result indicating that the attribution test application is in an installed state, wherein the second start instruction is used to instruct the second terminal to start the attribution test application;
sending a second installation instruction to the second terminal in response to the application detection result indicating that the attribution test application is in an uninstalled state, and sending the second start instruction to the second terminal after the attribution test application has been installed, wherein the second installation instruction is used to instruct the second terminal to install the attribution test application.

9. The method according to claim 1, wherein the attribution detection result further carries an attribution test image at the second terminal, and before the sending a preset control instruction to a second terminal, the method further comprises:
sending a screen recording instruction to the second terminal, wherein the screen recording instruction is used to instruct the second terminal to perform screen recording, to obtain the attribution test image at the second terminal; and
wherein before the generating, based on the attribution detection result and an expected detection result for the application to be tested, an attribution test result for the application to be tested, the method further comprises:
receiving the attribution test image that is returned by the second terminal in response to the screen recording instruction.

10. An attribution test method, applied to a second terminal, the second terminal having an application to be tested installed therein, the method comprising:
performing, in response to a preset control instruction sent by a first terminal, attribution detection on an installation channel of the application to be tested and generating an attribution detection result; and
sending the attribution detection result to the first terminal, wherein the attribution detection result is used by the first terminal to generate an attribution test result.

11. The method according to claim 10, wherein the preset control instruction comprises a first start instruction, and the performing, in response to a preset control instruction sent by a first terminal, attribution detection on an installation channel of the application to be tested and generating an attribution detection result comprises:
starting the application to be tested in response to the first start instruction sent by the first terminal;
presenting attribution prompt information in response to an operation prompt instruction sent by the first terminal, wherein the attribution prompt information is used to prompt a tester to perform an attribution operation; and
generating the attribution detection result through the application to be tested in response to the attribution operation performed by the tester.

12. The method according to claim 11, wherein the second terminal further has an attribution test application installed therein, and before the starting the application to be tested in response to the first start instruction sent by the first terminal, the method further comprises:
performing environment detection through the attribution test application in response to an environment detection instruction sent by the first terminal, and generating an environment detection result, wherein the environment detection comprises network environment detection, and/or installation status detection for the application to be tested; and
sending the environment detection result to the first terminal through the attribution test application.

13. The method according to claim 12, wherein after the sending the environment detection result to the first terminal through the attribution test application, the method further comprises:
installing, in response to a first installation instruction sent by the first terminal in a case where the environment detection result indicates that the application to be tested is in an uninstalled state, the application to be tested whose application version corresponds to target version information carried in the first installation instruction.

14. The method according to claim 12, wherein the attribution test result corresponds to a target test scenario, and before the performing environment detection through the attribution test application in response to an environment detection instruction sent by the first terminal, the method further comprises:
presenting a scenario identifier of at least one candidate test scenario through the attribution test application in response to a scenario presentation instruction sent by the first terminal; and
sending a target scenario identifier to the first terminal in response to a selection operation of the tester for the target test scenario from the at least one candidate test scenario, wherein the target scenario identifier is a scenario identifier of the target test scenario.

15. The method according to claim 10, wherein after the sending the attribution detection result to the first terminal, the method further comprises at least one of the following:
obtaining display position information of the application to be tested in the second terminal in response to an information obtaining instruction sent by the first terminal, and sending the display position information to the first terminal;
presenting, through the attribution test application and in response to a result presentation instruction sent by the first terminal, the attribution test result carried in the result presentation instruction; and
presenting reporting prompt information through the attribution test application in response to a reporting prompt instruction sent by the first terminal, wherein the reporting prompt information is used to trigger reporting of the attribution test result.

16. The method according to claim 10, wherein the sending the attribution detection result to the first terminal comprises:
sending, through the attribution test application, a result obtaining request carrying a preset signature to the application to be tested, wherein the result obtaining request is used to request obtaining of the attribution detection result generated by the application to be tested;
sending the attribution detection result to the attribution test application through the application to be tested in response to the preset signature matching a target signature of the application to be tested; and
receiving, through the attribution test application, the attribution detection result sent by the application to be tested, and sending the attribution detection result to the first terminal.

17. The method according to claim 10, wherein the attribution detection result is sent by the attribution test application to the first terminal, and before the performing, in response to a preset control instruction sent by a first terminal, attribution detection on an installation channel of the application to be tested and generating an attribution detection result, the method further comprises:
performing installation status detection on the attribution test application in response to an installation detection instruction sent by the first terminal, generating an application detection result, and sending the application detection result to the first terminal;
installing the attribution test application in response to a second installation instruction sent by the first terminal in a case where the attribution test application is in an uninstalled state; and
starting the attribution test application in response to a second start instruction sent by the first terminal in a case where the attribution test application is in an installed state or in a case where the attribution test application has been installed.

18. The method according to claim 10, wherein the attribution detection result further carries an attribution test image at the second terminal, and the method further comprises:
performing screen recording in response to a screen recording instruction sent by the first terminal, to obtain the attribution test image, and sending the attribution test image to the first terminal.

19. An electronic device, comprising:
at least one processor; and
a memory communicatively connected to the at least one processor, wherein
the memory stores a computer program executable by the at least one processor, and the computer program, when executed by the at least one processor, causes the at least one processor to:
send a preset control instruction to a second terminal, wherein the preset control instruction is used to instruct the second terminal to perform attribution detection on an installation channel of an application to be tested and generate an attribution detection result, and the application to be tested is installed in the second terminal;
receive the attribution detection result that is returned by the second terminal in response to the preset control instruction; and
generate, based on the attribution detection result and an expected detection result for the application to be tested, an attribution test result for the application to be tested.

20. An electronic device, comprising:
at least one processor; and
a memory communicatively connected to the at least one processor, wherein
the memory stores a computer program executable by the at least one processor, and the computer program, when executed by the at least one processor, causes the at least one processor to perform the attribution test method according to claim 10.
